(19) United States
(12) Patent Application Publication
(10) Pub. No.: US 2026/0063971 A1
(43) Pub. Date: Mar. 5, 2026

(54) Trigger Device Based on Resilient Structure

(71) Applicant: Dongguan Miles Precision Manufacturing Co., Ltd, Dongguan (CN)

(72) Inventor: Jun Ouyang, Dongguan (CN)

(21) Appl. No.: 18/900,970

(22) Filed: Sep. 30, 2024

(30) Foreign Application Priority Data
Sep. 4, 2024 (CN) 202411239795.1

(51) Int. Cl. G03B 17/02

(52) U.S. Cl. CPC G03B 17/02

(57) ABSTRACT

The present disclosure belongs to the technical field of trigger devices of cameras, and particularly relates to a trigger device based on a resilient structure, including the resilient structure, a connecting piece and a toggle piece, wherein one end of the connecting piece is connected with the toggle piece, the other end of the connecting piece is connected with the resilient structure, the resilient structure has a first stroke moving with the toggle piece, the resilient structure has a second stroke for elastic deformation, and the resilient structure has at least one trigger end. In the present disclosure, quick half-pressed shutter focusing and full-pressed stable shooting can be achieved, so as to improve the experience feeling of a user.

### CROSS REFERENCE TO RELATED APPLICATIONS

The present application claims the benefit of Chinese Patent Application No. 202411239795.1 filed on Sep. 4, 2024, the contents of which are incorporated herein by reference in their entirety.

### TECHNICAL FIELD

The present disclosure belongs to the technical field of trigger devices of cameras, and particularly relates to a trigger device based on a resilient structure.

### BACKGROUND ART

During shooting, a trigger device is an accessory device indispensable for achieving shooting. For the trigger device, a user presses a shutter button to contact the trigger device, so as to achieve shooting. A trigger of a common camera generally achieves half-pressing of a camera shutter by adopting a way of combining a plurality of gears for deceleration, for example, for a high-touch shutter releaser with Patent No. US 2011/0311210 A1, a half-pressed shutter button in this patent can trigger an automatic focusing function, and a full-pressed shutter button can take a photo; although the trigger device can provide relatively high touch through a mechanism connected with a shutter release button of the camera, so as to prevent the user from accidentally taking the picture when focusing intentionally, the trigger device combined by a plurality of gear structures fixes a force of the shutter button, when the shutter button is too far from the trigger device, a very high pressing force is required, thereby being inconvenient to use, and shutter buttons of the cameras of different types cannot be adjusted to a customary force commonly used by the user, thereby affecting the experience feeling of the user.

### SUMMARY OF THE INVENTION

In order to solve the above problems, an object of the present disclosure is to provide a trigger device based on a resilient structure. The trigger device has a simple structure and can be adjusted to a customary force commonly used by a user according to different shutter buttons of cameras, so as to achieve accurate half-pressed and full-pressed stable shooting, and improve the experience feeling of the user.

In order to achieve the above object, the present disclosure provides the following technical solution:
a trigger device based on a resilient structure includes the resilient structure, a connecting piece and
a toggle piece, wherein one end of the connecting piece is connected with the toggle piece, the other end of the connecting piece is connected with the resilient structure, the resilient structure has a first stroke moving with the toggle piece, the resilient structure has a second stroke for elastic deformation, and the resilient structure has at least one trigger end.

In the present disclosure, the first stroke of the resilient structure can enable the resilient structure to have a rotation radian range of corresponding rotation when the toggle piece is rotated, and when the toggle piece is lightly pressed, the connecting piece is driven to rotate correspondingly, the trigger end of the resilient structure is pressed to a shutter button, a camera is in a half-pressed state, and the second stroke achieving the elastic deformation can enable the camera to focus; an acting force on the resilient structure gradually increases by continuing to press the toggle piece or fully pressing the toggle piece in the case where focusing is not required until a stroke and a force of a shutter break through a half-pressed range of the shutter button of the camera, and the trigger end presses the shutter button sufficiently, so that shutter exposure is triggered; and through the arrangement of the trigger device, not only the structure is simple, but also a trigger function is more stable and flexible, so that quick half-pressed shutter focusing and full-pressed stable shooting can be achieved, so as to improve the experience feeling of the user.

Further, the resilient structure includes a mounting assembly and an elastic assembly, the elastic assembly is connected with the connecting piece through the mounting assembly, the elastic assembly is provided with at least one trigger end, and the elastic assembly has a second stroke for elastic deformation; through such a structural arrangement, when the toggle piece is pressed, the trigger end on the elastic assembly elastically expands and contracts with the elastic deformation, and a half-pressed maximum stroke of the camera is achieved at a critical value reached when the trigger end presses the shutter button, namely the focusing of the camera is reached; and pressing is continued to be beyond the critical value until shutter exposure is achieved to take a photo.

Further, the mounting assembly includes a mounting outer cover, the other end of the connecting piece is provided with a mounting inner cover movably connected with the mounting outer cover, and the mounting outer cover and the mounting inner cover are enclosed to form an accommodating chamber for accommodating the elastic assembly, so that the elastic assembly elastically expands and contracts in the accommodating chamber to trigger the shutter button.

Preferably, an inner side of the mounting outer cover is provided with an internal threaded structure, an outer side of the mounting inner cover is provided with an external threaded structure, and the internal threaded structure is rotatably connected with the external threaded structure. Such a structural arrangement not only achieves stable movable connection between the mounting outer cover and the mounting inner cover, but also can achieve convenient and quick replacement. A compression degree of the elastic assembly can also be rotatably adjusted by the mounting outer cover and the mounting inner cover, thereby adjusting a magnitude of an initial elastic force of the elastic assembly during operation.

Specifically, through the structural arrangement, a force for pressing the shutter is adjusted to a customary force of the user; when the shutter button of the camera is relatively far from the elastic assembly, the toggle piece is prevented from being toggled by using an excessive force, and the mounting outer cover and the mounting inner cover can be rotatably connected preliminarily, so that the force for pressing of the user is controlled at an initial elastic force value; and when the shutter button of the camera is relatively close to the elastic assembly, the user is prevented from being likely to touch the shutter button accidentally by using a relatively small force, the mounting outer cover and the mounting inner cover can be rotatably connected sufficiently, and after a distance between the two is decreased, the force for pressing the toggle piece is controlled at the initial elastic force value.

Further, the mounting outer cover is provided with a movable through hole, and the elastic assembly is at least partially exposed out of the movable through hole to form the trigger end. A diameter of the movable through hole is less than a size of the elastic assembly, so that the trigger end can be exposed and brought into pressing contact with the shutter button to trigger the shutter button for shutter focusing or shutter exposure.

Further, the elastic assembly includes a movable spring and a trigger block, the trigger block includes a trigger portion and a limiting portion, the trigger portion is integrally connected with the limiting portion, one end of the movable spring abuts against the limiting portion, and the trigger portion is at least partially exposed out of the movable through hole to form the trigger end, so as to trigger the shutter button.

Further, the limiting portion extends to form a limiting protrusion, the limiting protrusion is integrally connected with the limiting portion, and the limiting protrusion can be clamped at a bottom of the movable spring, so that the two are fixed more stably, and a phenomenon of displacement of the trigger block and the movable spring is avoided.

Further, the connecting piece includes a connecting plate and a connecting rod, the connecting plate includes a connecting portion and a turning portion, the connecting portion and the turning portion are connected and form a first included angle, one end of the connecting rod is connected with the connecting portion, the other end of the connecting rod is connected with the toggle piece, and the turning portion is connected with the resilient structure.

Preferably, the connecting portion and the connecting rod are fixedly mounted by arranging screws, one end of the connecting rod is sleeved with a torsional spring, and the torsional spring is arranged, so that when the toggle piece is pressed, the torsional spring is elastically deformed, and elastic potential energy of the torsional spring can be converted into kinetic energy, and then the toggle piece is correspondingly subjected to an acting force to rebound so as to reset.

Further, one end of the connecting rod is further sleeved with a waterproof sealing ring, and the waterproof sealing ring is arranged, so that the camera can perform underwater shooting after the trigger device is mounted, so as to prevent the trigger device from being damaged by water entering the trigger device.

Further, a shaft sleeve is mounted on the waterproof sealing ring, the shaft sleeve is provided with an external threaded structure, and the arrangement of the shaft sleeve and the external threaded structure can achieve more stable mounting with a camera housing.

Further, the toggle piece includes a toggle piece main body, the toggle piece main body is provided with a connecting through hole, and the connecting piece is snap-fitted with the connecting through hole. The toggle piece further includes a screw cover and a decorative sheet; and the screw cover and the decorative sheet are respectively arranged at side edges of the connecting through hole for dust prevention and waterproofness.

Further, a shaft piece is mounted at the other end of the connecting rod, the toggle piece main body is arranged between the shaft sleeve and the shaft piece, and the shaft piece is adapted to a size of the connecting through hole, so that the toggle piece is more closely mounted with the connecting piece.

The present disclosure further provides a trigger device based on a resilient structure. The above mounting outer cover is replaced with an adjusting piece, the movable spring and the trigger block are replaced with an elastic sheet, the elastic sheet includes a first elastic sheet arm, a second elastic sheet arm and a connecting portion which are combined to form a deformation space, the first elastic sheet arm is provided with a movable through hole, the first elastic sheet arm passes through the movable through hole to connect the adjusting piece with the turning portion, and the adjusting piece is telescopically arranged on the first elastic sheet arm to adjust a distance between the adjusting piece and the second elastic sheet arm.

Further, the adjusting piece is provided with a groove, and a positioning portion is mounted in the groove to clamp and fix one end of the turning portion. Specifically, the positioning portion is provided with an opening, and the positioning portion is slidably mounted in the groove through the opening to be fixed, so that the connection between the elastic sheet and the adjusting piece is more stable with the fixation of a clamping sheet, and no shaking occurs.

Further, the elastic sheet is a curved elastic sheet, and a space formed by curving the curved elastic sheet can be used for placing a bolt and the clamping sheet, thereby not only saving the space, but also adjusting an elastic force value for pressing the shutter button to adapt to pressing forces of different cameras and users. Specifically, the elastic sheet is curved into a U-shape to form an upper elastic sheet arm and a lower elastic sheet arm positioned on two sides of the opening, the bolt is rotatably connected to the upper elastic sheet arm, a front end of the bolt extends into the space formed by the curving, a deformation distance can be formed between the front end of the bolt and the lower elastic sheet arm, the deformation distance is used for providing a deformation space for the lower elastic sheet arm, and when the lower elastic sheet arm is subjected to pressure, the lower elastic sheet arm can deform upwards to be close to the upper elastic sheet arm, and will not continue to deform until the lower elastic sheet arm abuts against the front end of the bolt. However, when the lower elastic sheet arm has just reached a position where the lower elastic sheet arm abuts against the front end of the bolt, namely a critical elastic force value provided for deformation of the lower elastic sheet arm, this critical elastic force value is an ideal force for focusing and half-pressing of the camera in the present technical solution. According to different usage scenarios, a distance between the front end of the bolt and the lower elastic sheet arm can be adjusted to provide different critical elastic force values.

The present disclosure further provides a trigger device based on a resilient structure. The above mounting outer cover is replaced with a connecting structure, the movable spring and a steel ball are replaced with a resilient block, a resilient ball is provided with a movable through hole, and the connecting structure is connected with the resilient block through the movable through hole.

When the toggle piece is toggled, the connecting structure rotates correspondingly, and then a half-ball can be driven by the connecting structure to move downwards. As the half-ball can abut against a shutter button of a camera in use, the half-ball can be extruded with the shutter button of the camera during movement, and elastically deformed in a direction of the connecting structure.

When the resilient ball is sufficiently extruded with the connecting structure, the connecting structure can abut against the resilient ball, and at this moment, the critical elastic force value of the elastic deformation of the resilient ball is an ideal force for focusing and half-pressing of the camera in the present technical solution, and pressing is continued to be beyond the critical value, so that camera exposure can be achieved.

Further, the connecting structure includes a threaded rod and a connecting block, the threaded rod and the connecting block are integrally connected, a protrusion is further arranged below the threaded rod, and the protrusion is snap-fitted with the movable through hole. Such a structural arrangement achieves firm connection between the resilient ball and the connecting structure.

Further, one end of a connecting plate is provided with a threaded through hole, and the threaded rod is rotatably connected with the threaded through hole. Such a structural arrangement not only enables the connecting structure to be mounted with the connecting plate more stably, conveniently and quickly, but also can correspondingly adjust a compression degree of an elastic assembly by adjusting a distance between the threaded through hole and the threaded rod, thereby adjusting a magnitude of an initial elastic force of the elastic assembly during operation.

Specifically, through the structural arrangement, a force for pressing the shutter is adjusted to a customary force of the user; when the shutter button of the camera is relatively far from the elastic assembly, the toggle piece is prevented from being toggled by using an excessive force, and the distance between the threaded through hole and the threaded rod can be increased. When the shutter button of the camera is relatively close to the elastic assembly, the user is prevented from being likely to touch the shutter button accidentally by using a relatively small force, the distance between the threaded through hole and the threaded rod can be decreased.

Further, the device further includes a camera main body and a camera housing, the camera main body is mounted in the camera housing, the connecting piece is mounted on the camera housing in a manner of rotatable connection, the camera main body is provided with a shutter button, the elastic assembly corresponds to the shutter button in position, and the shutter button on the camera main body abuts against the resilient structure of the trigger device to trigger the shutter.

The beneficial effects of the present disclosure are as follows: compared with the prior art, in the present disclosure, the first stroke of the resilient structure can enable the resilient structure to have a rotation radian range of corresponding rotation when the toggle piece is rotated, and when the toggle piece is lightly pressed, the connecting piece is driven to rotate correspondingly, the trigger end of the resilient structure is pressed to the shutter button, the camera is in a half-pressed state, and the second stroke achieving the elastic deformation can enable the camera to focus; an acting force on the resilient structure gradually increases by continuing to press the toggle piece or fully pressing the toggle piece in the case where focusing is not required until a stroke and a force of the shutter break through a half-pressed range of the shutter button of the camera, and the trigger end presses the shutter button sufficiently, so that shutter exposure is triggered; and through the arrangement of the trigger device, not only the structure is simple, but also a trigger function is more stable and flexible, so that quick half-pressed shutter focusing and full-pressed stable shooting can be achieved, so as to improve the experience feeling of the user.

### BRIEF DESCRIPTION OF THE DRAWINGS

FIG. 1 is a schematic view of an overall structure of the present disclosure.

FIG. 2 is a schematic view of a first explosive structure of the present disclosure.

FIG. 3 is a schematic view of a structure of an enlarged view at A of FIG. 2.

FIG. 4 is a schematic view of another structure of the enlarged view at A of FIG. 2.

FIG. 5 is a schematic view of a second explosive structure of the present disclosure.

FIG. 6 is a schematic view of a structure of a second example of the present disclosure.

FIG. 7 is a schematic view of an explosive structure of the second example of the present disclosure.

FIG. 8 is an enlarged view at B of FIG. 7.

FIG. 9 is a schematic view of a structure of a third example of the present disclosure.

FIG. 10 is a schematic view of an explosive structure of a third example of the present disclosure.

FIG. 11 is an enlarged view at C of FIG. 10.

FIG. 12 is a schematic view of a structure mounted on a camera and a camera housing of the first example.

FIG. 13 is a schematic view of a structure mounted on the camera and the camera housing of the second example.

FIG. 14 is a schematic view of a structure mounted on the camera and the camera housing of the third example.

### DETAILED DESCRIPTION OF THE INVENTION

In order that the objects, technical solutions and advantages of the present disclosure will become more apparent, a more detailed description of the present disclosure will be rendered in conjunction with accompanying drawings and examples. It should be understood that the particular examples described herein are illustrative of the present disclosure only and are not intended to limit the present disclosure.

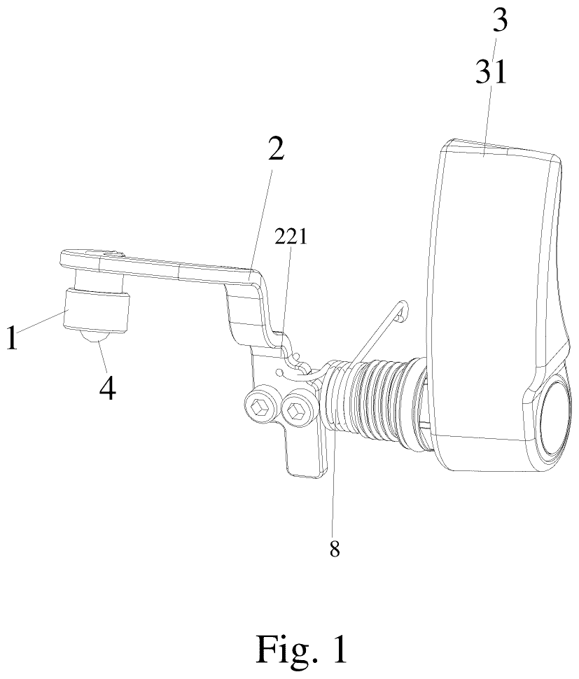

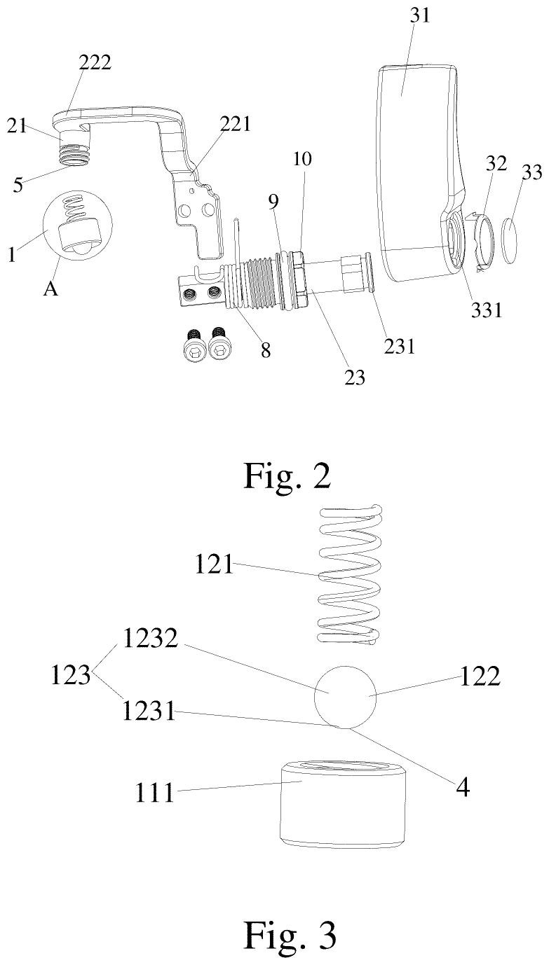

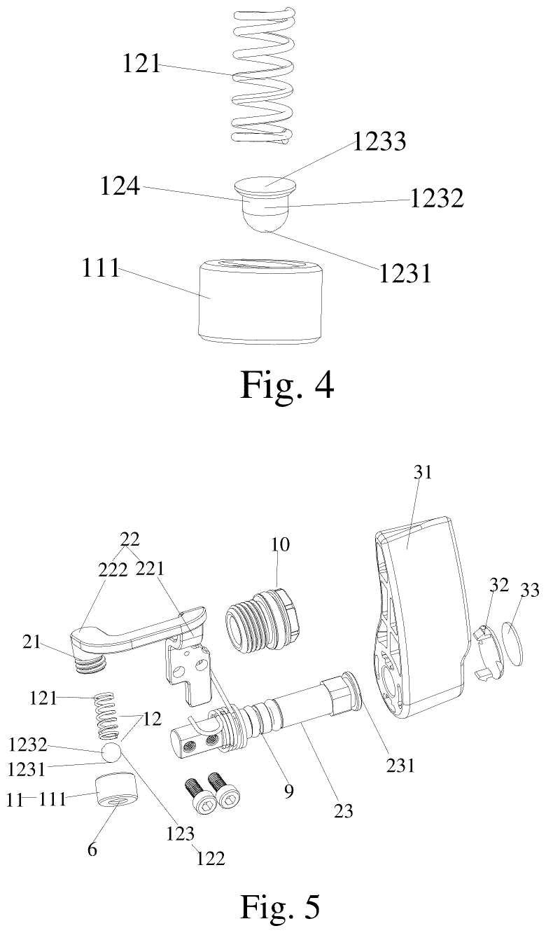

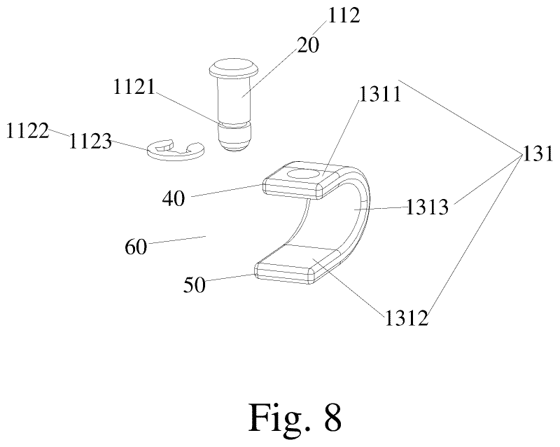

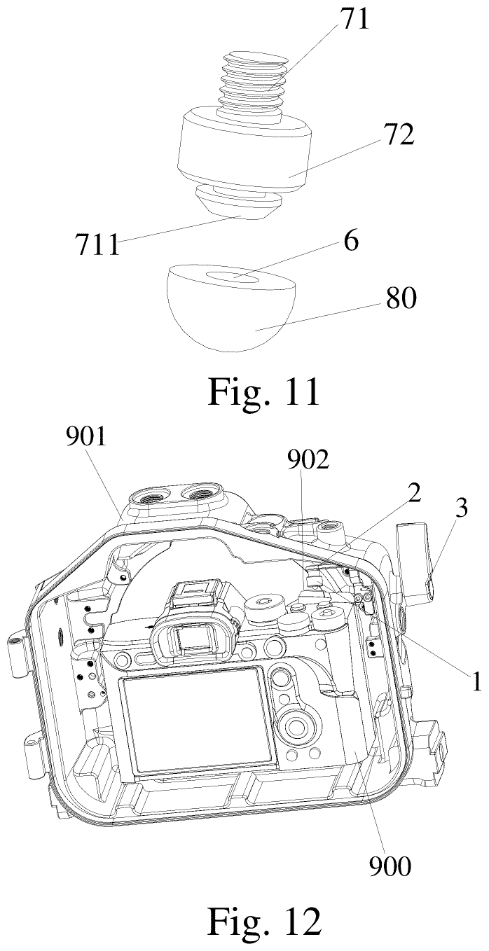

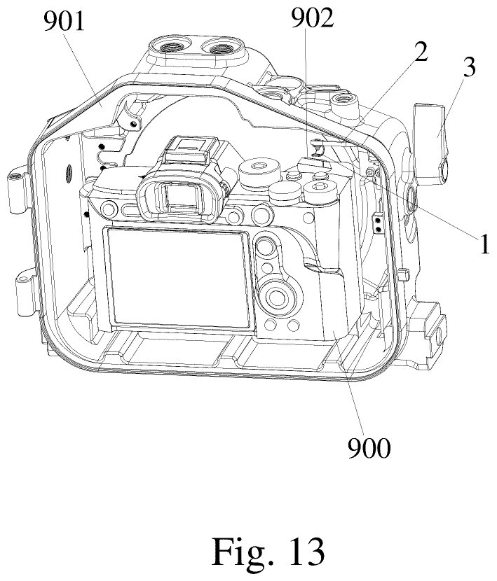

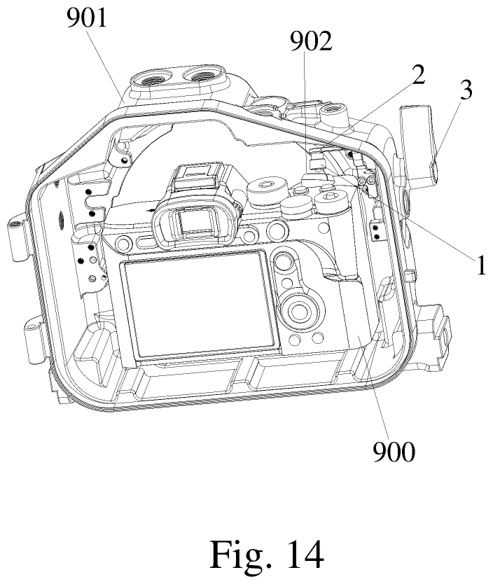

With reference to FIGS. 1-14, in order to achieve the above objects, the technical solutions of the present disclosure are as follows:

A trigger device based on a resilient structure includes the resilient structure 1, a connecting piece 2 and a toggle piece 3, wherein one end of the connecting piece 2 is connected with the toggle piece 3, the other end of the connecting piece 2 is connected with the resilient structure 1, the resilient structure 1 has a first stroke moving with the toggle piece 3, the resilient structure 1 has a second stroke for elastic deformation, and the resilient structure 1 has at least one trigger end 4.

In the present disclosure, the first stroke of the resilient structure 1 can enable the resilient structure 1 to have a rotation radian range of corresponding rotation when the toggle piece 3 is rotated, and when the toggle piece 3 is lightly pressed, the connecting piece 2 is driven to rotate correspondingly, the trigger end 4 of the resilient structure 1 is pressed to a shutter button, a camera is in a half-pressed state, and the second stroke achieving the elastic deformation can enable the camera to focus; an acting force on the resilient structure 1 gradually increases by continuing to press the toggle piece or fully pressing the toggle piece 3 in the case where focusing is not required until a stroke and a force of a shutter break through a half-pressed range of the shutter button of the camera, and the trigger end presses the shutter button sufficiently, so that shutter exposure is triggered; and through the arrangement of the trigger device, not only the structure is simple, but also a trigger function is more stable and flexible, so that quick half-pressed shutter focusing and full-pressed stable shooting can be achieved.

In this example, the resilient structure 1 includes a mounting assembly 11 and an elastic assembly 12, the elastic assembly 12 is connected with the connecting piece 2 through the mounting assembly 11, the elastic assembly 12 is provided with at least one trigger end 4, and the elastic assembly 12 has a second stroke for elastic deformation; through such a structural arrangement, when the toggle piece 3 is pressed, the trigger end on the elastic assembly 12 elastically expands and contracts with the elastic deformation, and a half-pressed maximum stroke of the camera is achieved at a critical value reached when the trigger end 4 presses the shutter button, namely the focusing of the camera is reached; and pressing is continued to be beyond the critical value until shutter exposure is achieved to take a photo.

In this example, the mounting assembly 11 includes a mounting outer cover 111, the other end of the connecting piece 2 is provided with a mounting inner cover 21 movably connected with the mounting outer cover 111, and the mounting outer cover 111 and the mounting inner cover 21 are enclosed to form an accommodating chamber 5 for accommodating the elastic assembly 12, so that the elastic assembly 12 elastically expands and contracts in the accommodating chamber 5 to trigger the shutter button.

Preferably, an inner side of the mounting outer cover 111 is provided with an internal threaded structure, an outer side of the mounting inner cover 21 is provided with an external threaded structure, and the internal threaded structure is rotatably connected with the external threaded structure. Such a structural arrangement not only achieves stable movable connection between the mounting outer cover and the mounting inner cover, but also can achieve convenient and quick replacement. A compression degree of the elastic assembly 12 can also be rotatably adjusted by the mounting outer cover 111 and the mounting inner cover 21, thereby adjusting a magnitude of an initial elastic force of the elastic assembly 12 during operation.

Specifically, through the structural arrangement, a force for pressing the shutter is adjusted to a customary force of the user; when the shutter button of the camera is relatively far from the elastic assembly, the toggle piece 3 is prevented from being toggled by using an excessive force, and the mounting outer cover 111 and the mounting inner cover 21 can be rotatably connected preliminarily, so that the force for pressing of the user is controlled at an initial elastic force value; and when the shutter button of the camera is relatively close to the elastic assembly 12, the user is prevented from being likely to touch the shutter button accidentally by using a relatively small force, the mounting outer cover 111 and the mounting inner cover 21 can be rotatably connected sufficiently, and after a distance between the two is decreased, the force for pressing the toggle piece is controlled at the initial elastic force value.

In this example, the mounting outer cover 111 is provided with a movable through hole 6, and the elastic assembly 12 is at least partially exposed out of the movable through hole 6 to form the trigger end 4. A diameter of the movable through hole 6 is less than a size of the elastic assembly 12, so that the trigger end 4 can be exposed and brought into pressing contact with the shutter button to trigger the shutter button for shutter focusing or shutter exposure.

In this example, the elastic assembly 12 includes a movable spring 121 and a trigger block 122, the trigger block is a ball body 123, a bottom of the ball body 123 is a trigger portion 1231, a middle of the ball body 123 is a limiting portion 1232, the trigger portion 1231 is integrally connected with the limiting portion 1232, one end of the movable spring 121 abuts against the limiting portion 1232, and the trigger portion 1231 is at least partially exposed out of the movable through hole 6 to form the trigger end 4, so as to trigger the shutter button.

In this example, the ball body 123 is replaced with an elliptical ball 124, the limiting portion 1232 extends to form a limiting protrusion 1233, the limiting protrusion 1233 is integrally connected with the limiting portion 1232, and the limiting protrusion 1233 can be clamped at a bottom of the movable spring 121, so that the two are fixed more stably, and a phenomenon of displacement of the elliptical ball 124 and the movable spring 121 is avoided.

In this example, the connecting piece 2 includes a connecting plate 22 and a connecting rod 23, the connecting plate 22 includes a connecting portion 221 and a turning portion 222, the connecting portion 221 and the turning portion 222 are connected and form a first included angle 7, one end of the connecting rod 23 is connected with the connecting portion 221, the other end of the connecting rod 23 is connected with the toggle piece 3, and the turning portion 222 is connected with the resilient structure 1.

Preferably, the connecting portion 221 and the connecting rod 23 are fixedly mounted by arranging screws, one end of the connecting rod 23 is sleeved with a torsional spring 8, and the torsional spring 8 is arranged, so that when the toggle piece 3 is pressed, the torsional spring 8 is elastically deformed, and elastic potential energy of the torsional spring 8 can be converted into kinetic energy, and then the toggle piece 3 is correspondingly subjected to an acting force to rebound so as to reset.

In this example, one end of the connecting rod 23 is further sleeved with a waterproof sealing ring 9, and the waterproof sealing ring 9 is arranged, so that the camera can perform underwater shooting after the trigger device is mounted, so as to prevent the trigger device from being damaged by water entering the trigger device.

In this example, a shaft sleeve 10 is mounted on the waterproof sealing ring 9, the shaft sleeve 10 is provided with an external threaded structure, and the arrangement of the shaft sleeve 10 and the external threaded structure can achieve more stable mounting with a camera housing.

In this example, the toggle piece 3 includes a toggle piece main body 31, the toggle piece main body 31 is provided with a connecting through hole 311, and the connecting rod 23 is snap-fitted with one end of the connecting through hole 311. The toggle piece 3 further includes a screw cover 32 and a decorative sheet 33; and the decorative sheet 33 is arranged at the other end of the connecting through hole 311, the screw cover 32 is arranged on the decorative sheet 33, and the screw cover 32 and the decorative sheet 33 are used for dust prevention and waterproofness.

In this example, a shaft piece 231 is mounted at the other end of the connecting rod 23, the toggle piece main body 31 is arranged between the shaft sleeve 10 and the shaft piece 231, and the shaft piece 231 is adapted to a size of the connecting through hole 311, so that the toggle piece 3 is more closely mounted with the connecting piece 2.

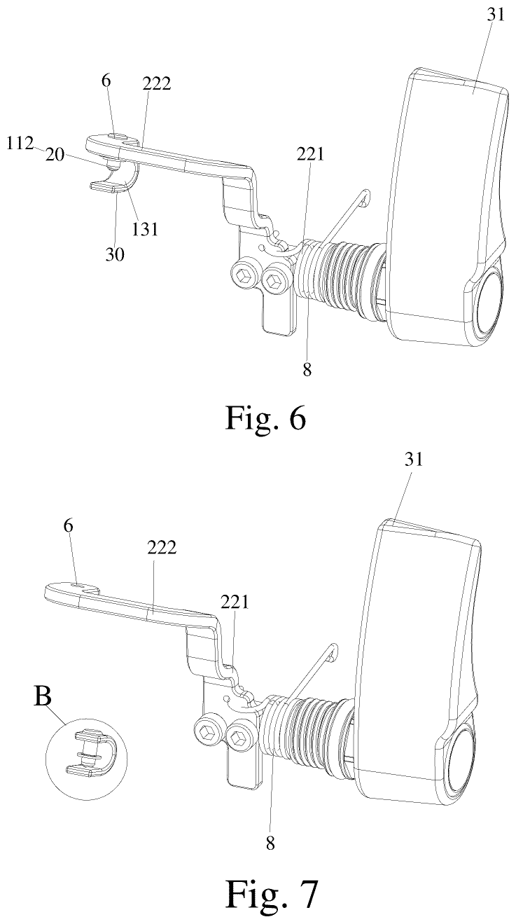

With reference to FIGS. 6-8, in a second example, the mounting outer cover 111 is replaced with an adjusting piece 112, the adjusting piece 112 is a bolt 20, the movable spring 121 and the trigger block 122 are replaced with an elastic sheet 131, the elastic sheet 131 includes a first elastic sheet arm 1311, a second elastic sheet arm 1312 and a connecting portion 1313 which are combined to form a deformation space, the first elastic sheet arm 1311 is provided with a movable through hole 6, the first elastic sheet arm 1311 passes through the movable through hole 6 to connect the bolt 20 with the turning portion 222, and the bolt 20 is telescopically arranged on the first elastic sheet arm 1311 to adjust a distance between the adjusting piece 112 and the second elastic sheet arm 1312.

In this example, the bolt 20 is provided with an annular groove 1121, a positioning portion 1122 is mounted in the annular groove 1121, and the positioning portion is a clamping sheet 1123, such a structure clamps and fixes one end of the turning portion 222. Specifically, the clamping sheet 1123 is provided with an opening, and the clamping sheet 1123 is slidably mounted in the annular groove 1121 through the opening to be fixed, so that the connection between the elastic sheet 131 and the bolt 20 is more stable with the fixation of the clamping sheet 1123, and no shaking occurs.

In this example, the elastic sheet 131 is a curved elastic sheet 30, and a space formed by curving the curved elastic sheet 30 can be used for placing the bolt 20 and the clamping sheet 1123, thereby not only saving the space, but also adjusting an elastic force value for pressing the shutter button to adapt to pressing forces of different cameras and users. Specifically, the elastic sheet 131 is curved into a U-shape to form an upper elastic sheet arm 40 and a lower elastic sheet arm 50 positioned on two sides of the opening, the bolt 20 is rotatably connected to the upper elastic sheet arm 40, a front end of the bolt 20 extends into the space formed by the curving, a deformation distance 60 can be formed between the front end of the bolt 20 and the lower elastic sheet arm 50, the deformation distance 60 is used for providing a deformation space for the lower elastic sheet arm 50, and when the lower elastic sheet arm 50 is subjected to pressure, the lower elastic sheet arm 50 can deform upwards to be close to the upper elastic sheet arm 40, and will not continue to deform until the lower elastic sheet arm 50 abuts against the front end of the bolt 20. However, when the lower elastic sheet arm 50 has just reached a position where the lower elastic sheet arm 50 abuts against the front end of the bolt 20, namely a critical elastic force value provided for deformation of the lower elastic sheet arm 50, this critical elastic force value is an ideal force for focusing and half-pressing of the camera in the present technical solution. According to different usage scenarios, a distance between the front end of the bolt 20 and the lower elastic sheet arm 50 can be adjusted to provide different critical elastic force values.

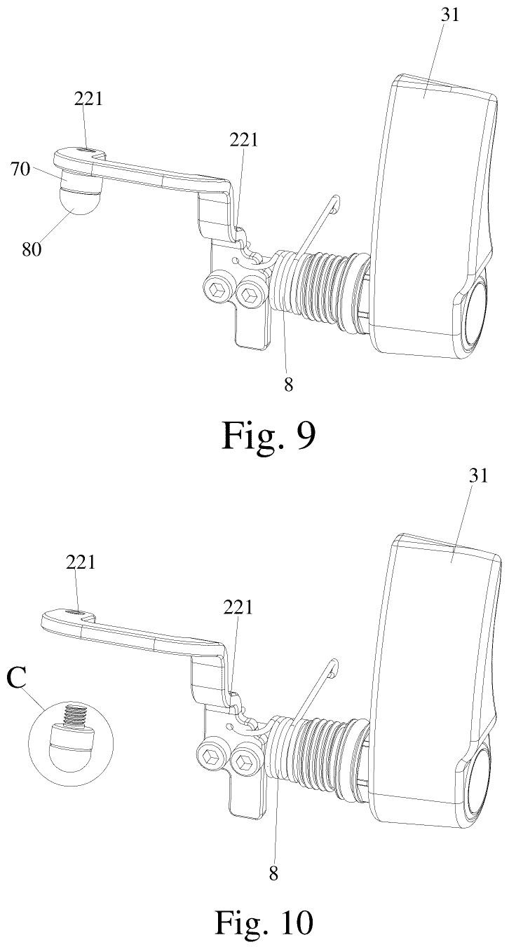

With reference to FIGS. 9-11, in a third example, the mounting outer cover 111 is replaced with a connecting structure 70, the movable spring 121 and the trigger block 122 are replaced with a half-ball 80, the half-ball 80 is provided with a movable through hole 6, and the connecting structure 70 is connected with the half-ball 80 through the movable through hole 6.

When the toggle piece 3 is toggled, the connecting structure 70 rotates correspondingly, and then the half-ball 80 can be driven by the connecting structure 70 to move downwards. As the half-ball 80 can abut against a shutter button of a camera in use, the half-ball 80 can be extruded with the shutter button of the camera during movement, and elastically deformed in a direction of the connecting structure 70. When the half-ball 80 is sufficiently extruded with the connecting structure, the connecting structure 70 can abut against the half-ball 80, and at this moment, the critical elastic force value of the elastic deformation of the half-ball 80 is an ideal force for focusing and half-pressing of the camera in the present technical solution, and pressing is continued to be beyond the critical value, so that camera exposure can be achieved.

Specifically, the half-ball 80 is made of a resilient material, and after the resilient structure 1 is extruded, the half-ball is elastically deformed to trigger the shutter.

In this example, the connecting structure 70 includes a threaded rod 71 and a connecting block 72, the threaded rod 71 and the connecting block 72 are integrally connected, a protrusion 711 is further arranged below the threaded rod 71, and the protrusion 711 is snap-fitted with the movable through hole 6. Such a structural arrangement achieves firm connection between the half-ball 80 and the connecting structure 70.

In this example, one end of a connecting plate 22 is provided with a threaded through hole 221, and the threaded rod 71 is rotatably connected with the threaded through hole 221. Such a structural arrangement not only enables the connecting structure 70 to be mounted with the connecting plate 22 more stably, conveniently and quickly, but also can correspondingly adjust a compression degree of an elastic assembly 12 by adjusting a distance between the threaded through hole 221 and the threaded rod 71, thereby adjusting a magnitude of an initial elastic force of the elastic assembly 12 during operation.

Specifically, through the structural arrangement, a force for pressing the shutter is adjusted to a customary force of the user; when the shutter button of the camera is relatively far from the elastic assembly 12, the toggle piece 3 is prevented from being toggled by using an excessive force, and the distance between the threaded through hole 221 and the threaded rod 71 can be increased.

When the shutter button of the camera is relatively close to the elastic assembly 12, the user is prevented from being likely to touch the shutter button accidentally by using a relatively small force, the distance between the threaded through hole 221 and the threaded rod 71 can be decreased.

In any example, the device further includes a camera main body 900 and a camera housing 901, the camera main body 900 is mounted in the camera housing 901, the connecting piece 2 is mounted on the camera housing 901 in a manner of rotatable connection, the camera main body is provided with a shutter button 902, the elastic assembly 3 corresponds to the shutter button 902 in position, and the shutter button 902 on the camera main body 900 abuts against the resilient structure 1 of the trigger device to trigger the shutter.

In order that the objects, technical solutions and advantages of the present disclosure will become more apparent, a more detailed description of the present disclosure will be rendered in conjunction with accompanying drawings and examples. It should be understood that the particular examples described herein are illustrative of the present disclosure only and are not intended to limit the present disclosure.

1. A trigger device based on a resilient structure, comprising the resilient structure, a connecting piece and a toggle piece, wherein one end of the connecting piece is connected with the toggle piece, the other end of the connecting piece is connected with the resilient structure, the resilient structure has a first stroke moving with the toggle piece, the resilient structure has a second stroke for elastic deformation, and the resilient structure has at least one trigger end.

2. The trigger device based on a resilient structure of claim 1, wherein the resilient structure comprises a mounting assembly and an elastic assembly, the elastic assembly is connected with the connecting piece through the mounting assembly, the elastic assembly is provided with at least one trigger end, and the elastic assembly has a second stroke for elastic deformation.

3. The trigger device based on a resilient structure of claim 2, wherein the mounting assembly comprises a mounting outer cover, the other end of the connecting piece is provided with a mounting inner cover movably connected with the mounting outer cover, and the mounting outer cover and the mounting inner cover are enclosed to form an accommodating chamber for accommodating the elastic assembly.

4. The trigger device based on a resilient structure of claim 3, wherein the mounting outer cover is provided with a movable through hole, and the elastic assembly is at least partially exposed out of the movable through hole to form the trigger end.

5. The trigger device based on a resilient structure of claim 4, wherein the elastic assembly comprises a movable spring and a trigger block, the trigger block comprises a trigger portion and a limiting portion, the trigger portion is connected with the limiting portion, one end of the movable spring abuts against the limiting portion, and the trigger portion is at least partially exposed out of the movable through hole to form the trigger end.

6. The trigger device based on a resilient structure of claim 1, wherein the connecting piece comprises a connecting plate and a connecting rod, the connecting plate comprises a connecting portion and a turning portion, the connecting portion and the turning portion are connected and form a first included angle, one end of the connecting rod is connected with the connecting portion, the other end of the connecting rod is connected with the toggle piece, and the turning portion is connected with the resilient structure.

7. The trigger device based on a resilient structure of claim 1, wherein the toggle piece comprises a toggle piece main body, the toggle piece main body is provided with a connecting through hole, and the connecting piece is snap-fitted with the connecting through hole.

8. The trigger device based on a resilient structure of claim 2, wherein the mounting assembly comprises an adjusting piece, the elastic assembly comprises an elastic sheet, the elastic sheet comprises a first elastic sheet arm, a second elastic sheet arm and a connecting portion which are combined to form a deformation space, the first elastic sheet arm is connected with the connecting piece through the adjusting piece, and the adjusting piece is telescopically arranged on the first elastic sheet arm to adjust a distance between the adjusting piece and the second elastic sheet arm.

9. The trigger device based on a resilient structure of claim 2, wherein the mounting assembly comprises a connecting structure, the elastic assembly comprises a resilient block, the resilient block is provided with a movable through hole, and the connecting structure is connected with the resilient block through the movable through hole.

10. The trigger device based on a resilient structure of claim 2, further comprising a camera main body and a camera housing, wherein the camera main body is mounted in the camera housing, the connecting piece is mounted on the camera housing in a manner of rotatable connection, the camera main body is provided with a shutter button, and the elastic assembly corresponds to the shutter button in position.
